(19) United States
(12) Patent Application Publication
(10) Pub. No.: US 2024/0112079 A1
(43) Pub. Date: Apr. 4, 2024

(54) MACHINE-LEARNING TECHNIQUES FOR CARBON FOOTPRINT OPTIMIZATION FROM IMPROVED ORGANIZATION OF MEDIA

(71) Applicant: Ratin Kumar, Cupertino, CA (US)

(72) Inventors: Ashish Kumar Kashyap, Cupertino, CA (US); Samarth Kumar Kashyap, Cupertino, CA (US)

(21) Appl. No.: 17/960,073

(22) Filed: Oct. 4, 2022

(51) Int. Cl. G06N 20/00; G06F 16/93

(52) U.S. Cl. CPC G06N 20/00; G06F 16/93

(57) ABSTRACT

Apparatuses, systems, and techniques to enable optimizations in storage and processing of media based on identification of repititions between two or more media content. In at least one embodiment, one or more repition of content is identified based on properties of media included.

### TECHNICAL FIELD

At least one embodiment pertains to methods to optimize energy usage by identifying same, similar or modified images, movies, music and media contents. For example, at least one embodiment pertains to processors or computing systems used to identify similarity between two or more images according to various novel techniques described herein.

### BACKGROUND

Advent and proliferation of digital cameras and music and media creation and modification tools has enabled large growth of media content. This needs to be considered in conjunction with multiplicity of storage and backup options, both automated and not. As such, organization of images, movies, music and media content is iterative and often repeated. Hence making this process to be costly, time consuming and ineffective. This has resulted in a significant increase in duplicate content being stored and processed by individuals and businesses resulting in significant redundant usage of memory, time, and/or computing resources. With large media content getting used more frequently, indexing, search and retrieval operations has an ever-increasing energy requirement proportional to the amount of total, including duplicated, media content. Amounts of memory, time, or computing resources used to process and work with images, movies, music, and media can be improved. This will result in lower carbon footprint associated with media consumption.

### BRIEF DESCRIPTION OF DRAWINGS

FIG. 1 illustrates a diagram of a media organizer system, according to at least one embodiment;

FIG. 2 illustrates a diagram of an index generator, according to at least one embodiment;

FIG. 3 illustrates a diagram of an attribute parser, according to at least one embodiment;

FIG. 4 illustrates a diagram of a hash generator, according to at least one embodiment;

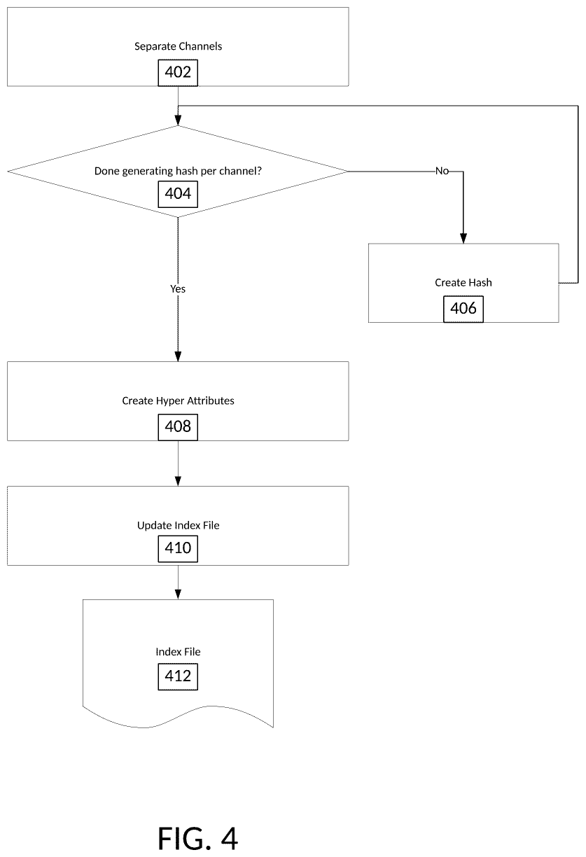

FIG. 5 illustrates a diagram of a content analyzer, according to at least one embodiment;

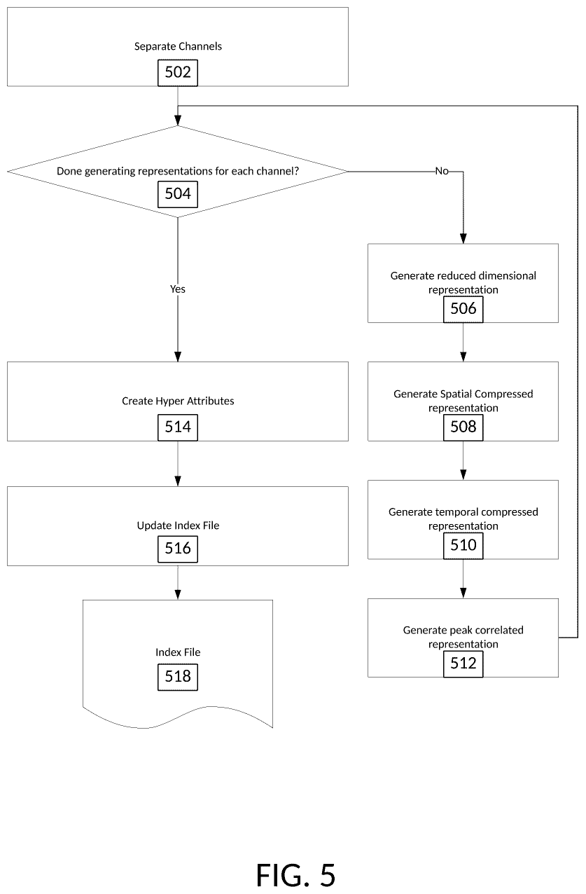

FIG. 6 illustrates a diagram of a loss analyzer, according to at least one embodiment;

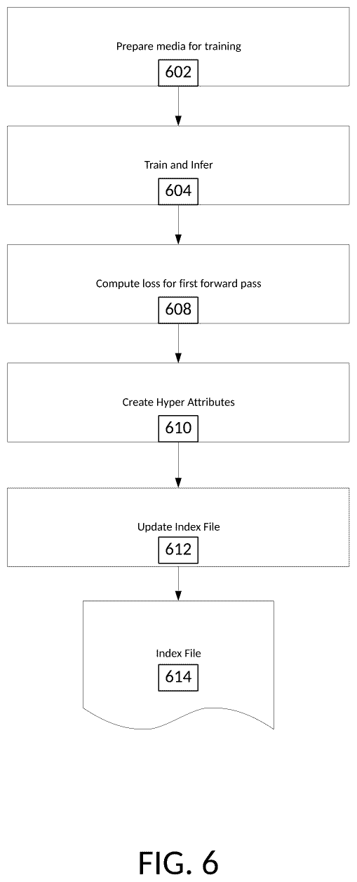

FIG. 7 illustrates a diagram of normalization operation, according to at least one embodiment;

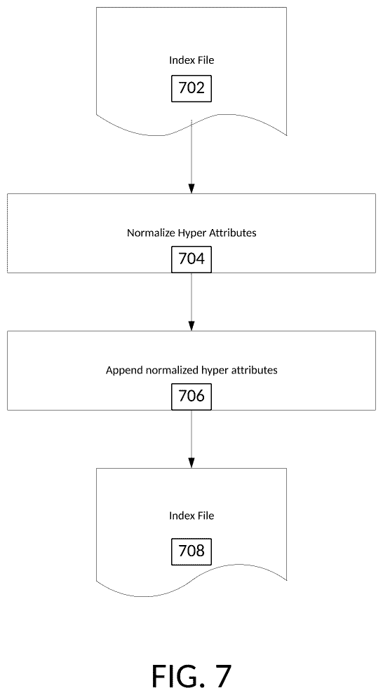

FIG. 8 illustrates a diagram of duplicate determination, according to at least one embodiment;

FIG. 9 illustrates a diagram of deep learning process to train a model

FIG. 10 illustrates a diagram of machine learning process of clustering

FIG. 11 illustrates machine learning method for determining frequency of occurrence of a string

FIG. 12 illustrates a diagram of the process of generating mel spectrograms

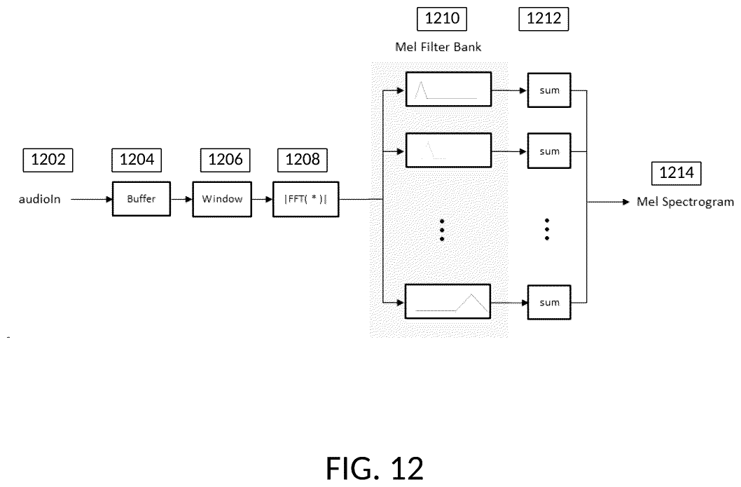

### DETAILED DESCRIPTION

In at least one embodiment, a media organization system is a collection of one or more computing resources that enables a computing system to identify repetitions of whole or part of content. In at least one embodiment, a media organization system is also referred to as a media organizer, media manager, image organizer, image tagger, duplicate finder, photo tool, and/or variations thereof. In at least one embodiment, a media organization system is a collection of one or more computing resources that conducts one or more operations on the media and associated data to assess repetitive nature of said media. In at least one embodiment, organization refers to interactive communication between system and user. In at least one embodiment, a media organization system utilizes a cross reference support system to uniquely learn and extract or identify unique features and create unique identifiers which are not otherwise available in the media content.

In at least one embodiment, duplicate refers to an altered copy of the media content. In at least one embodiment, duplicate refers to same content saved or referred to using different name. In at least one embodiment, duplicate refers to content saved with same or different name but with modified information that does not change the media content. In at least one embodiment, duplicate refers to content which is slightly modified among multiple occurrences to alter some attributes of the media. In at least one embodiment, the media organizer determines recurrence of features and attributes to identify opportunities to organize better and performs one or more processes based at least in part on said determination.

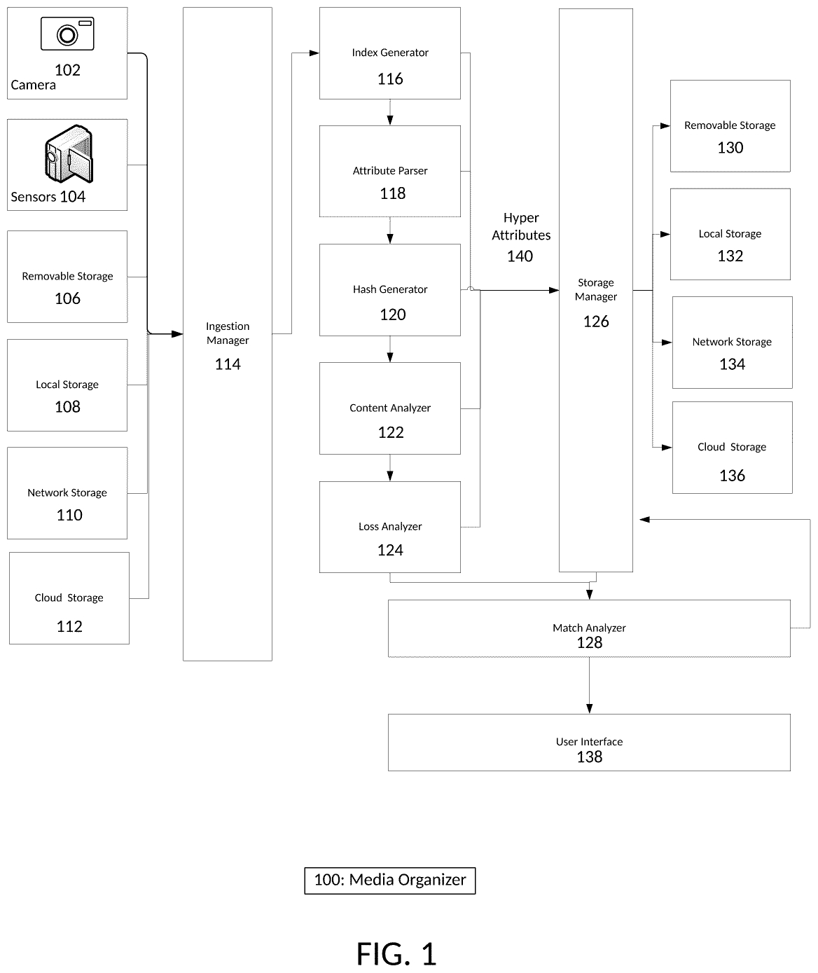

FIG. 1 illustrates a diagram 100 of a Media Organizer system, according to at least one embodiment. In at least one embodiment, a human user uses Media Organizer 100 to analyze and identify duplicate and redundant contents. In at least one embodiment, another program or programmatic entity uses Media Organizer 100 to analyze and identify duplicate and redundant contents. In at least one embodiment, a Media Organizer 100 receives images as input from a camera 102. In at least one embodiment, a Media Organizer 100 receives video and/or audio from a Sensor 104. In at least one embodiment, Sensor 104 can be microphone only or a camera with microphone. In at least one embodiment, a Media Organizer 100 receives images, video, audio, music or other media input from a removable storage 106. In at least one embodiment, a Media Organizer 100 works with removable storage 106, types like USB, SD card and other removable storage devices and devices offering storage functions. In at least one embodiment, Media Organizer 100 works with network attached storage 110. In at least one embodiment, Media Organizer 100 works with cloud attached storage 112.

In at least one embodiment, Media Organizer 100 has a software or hardware Ingestion Manager 114 to take media input from various devices and storage methods. In at least one embodiment, Ingestion Manager 114 can process streaming input from Camera 102 and sensors 104 and storage devices 106, 108 and 110. In at least one embodiment, Media Organizer 100 will process stored content from Camera 102 and Sensors 104 and storage devices 106, 108 and 110.

In at least one embodiment, media from Camera 102, Sensors 104, Removable Storage 106, Local Storage 108, Network Storage 110 and Cloud Storage 112 is an image. An image is any data that allows representation of a static set of pixels. In at least one embodiment the image is represented with color information as RGB, YUV, YCbCr or any other format. In at least one embodiment the image is compressed using one of, but not limited to, compression schemes like JPEG. In at least one embodiment the image compression may be lossy and not recreate original content. In at least one embodiment the image compression may be lossless and is able reproduce original content.

In at least one embodiment, media from Camera 102, Sensors 104, Removable Storage 106, Local Storage 108, Network Storage 110 and Cloud Storage 112 is a video file or video stream. In at least one embodiment, the said video stream is encoded using schemes like H.264 or H.265. In at least one embodiment, the said video is using container standards and video encoding and transmission standards published at and available, including but not limited to MPEG, Motion JPEG and AV formats. The said video can be live or recorded.

In at least one embodiment, media from Camera 102, Sensors 104, Removable Storage 106, Local Storage 108, Network Storage 110 and Cloud Storage 112 is an audio file or an audio stream. This can be, but not limited to, a collection of one or more audio segments of an audio stream, in which said audio stream is a live audio stream or recorded audio stream.

In at least one embodiment, Media Organizer 100 has an index generator 116 to analyze storage and generate an index of contents. Index generator 116 works with Ingestion Manager 114 to access one or more storage devices. In at least one embodiment the index generator may work with stored content. In at least one embodiment the image may work with live streaming content.

In at least one embodiment, Media Organizer 100 uses an Attribute Parser 118 to extract attributes of media. In at least one embodiment, image attributes like width, height, color space, encoding and encoding parameters and container defined meta data is extracted. In at least one embodiment the attribute is one or more physical properties of the media outside of the actual media content itself. Such physical properties include, but not limited to, file name, amount of storage needed for the file, time of creation, modification or transmission.

In at least one embodiment, Media Organizer 100 has a Hash Generator 120. The Hash Generator processes information other than what is processed by Attribute Parser to produce a lower dimension numerical representation of the content. In at least one embodiment, Hash Generator 120 will process image pixels. In at least one embodiment, Hash generator will process I frame data in video. In at least one embodiment, audio samples in a music or audio content are processed by Hash Generator 120. In at least one embodiment, the Hash Generator 120 will need to decompress the media content. In at least one embodiment, the Hash Generator 120 will rely on earlier stages to have decompressed the media content.

In at least one embodiment, Media Organizer 100 has a Content Analyzer 122. The Content Analyzer 122 using one or more algorithms, will derive one or more properties of the media content. In at least one embodiment, Media Organizer 100, uses one or more techniques from computer vision, digital signal processing, matrix multiplication, machine learning and deep learning to derive the said properties.

In at least one embodiment, Media Organizer 100 uses a Loss Analyzer 124. This uses machine learning methods to compute attribute of loss as a predefined mathematical function.

In at least one embodiment, Media Organizer 100 processes input to produce Hyper Attributes 140. Hyper Attributes are properties of media content that are extracted by Index Generator 116 and Attribute Parser 118. Hyper Attributes are also computational outputs from Hash Generator 120, Content Analyzer 122 and Loss analyzer 124. In at least one embodiment, Media Organizer 100 may use additional processing stages to generate one or more additional Hyper Attributes. In at least one embodiment, Media Organizer 100 uses Machine Learning to include big data analytics, traditional machine learning or one of various deep learning techniques for generating Hyper Attributes. In at least one embodiment, Media Organizer 100 uses string and numerical algorithms to create, process and standardize representation of Hyper Attributes.

In at least one embodiment, Media Organizer 100 uses a Storage Manager 126 to store initial, intermediate and final media content and intermediate and final generated information, including but not limited to index files and Hyper Attributes.

In at least one embodiment, Storage Manager 126 uses one or more of Removable Storage 130, Local Storage 132, Network Storage 134 and Cloud Storage 136. In at least one embodiment, this storage could be volatile storage using technologies like DRAM, SRAM and DDR4 or similar storage technologies. In at least one embodiment, this storage could be nonvolatile storage like optical or magnetic hard drive or SSDs or similar storage technologies.

In at least one embodiment, Media Organizer 100 has a Match Analyzer 128. In at least one embodiment, the Match Analyzer 128 uses index file and Hyper Attributes with a combination of one or more algorithms to determine the likelihood of two or more samples in the media content to be duplicates of each other. In at least one embodiment the Match Analyzer 128 will assess the likelihood of two or more media contents being similar to each other. In at least one embodiment, the Match Analyzer 128 will assess two or more media contents to be derived from each other or some other common source. Match Analyzer 128 may or may not be able to determine the original source for such duplicates, similar instances or derivatives.

In at least one embodiment, Media Organizer 100 has a User Interface 138 for user to start, monitor and interact with the system. The said interaction can include methods for showing probable conclusions. The said interaction can also include methods for user to make determinations where algorithmic determination may not be sufficient.

In at least one embodiment, User Interface 138 can be a way to use scripts to start, monitor and decide of intermediate and final states of operations of Media Organizer 100. In at least one embodiment, User Interface 138 can be an Application Programming Interface (API) to enable usage of Media Organizer 100 or parts of it through other software and hardware methods.

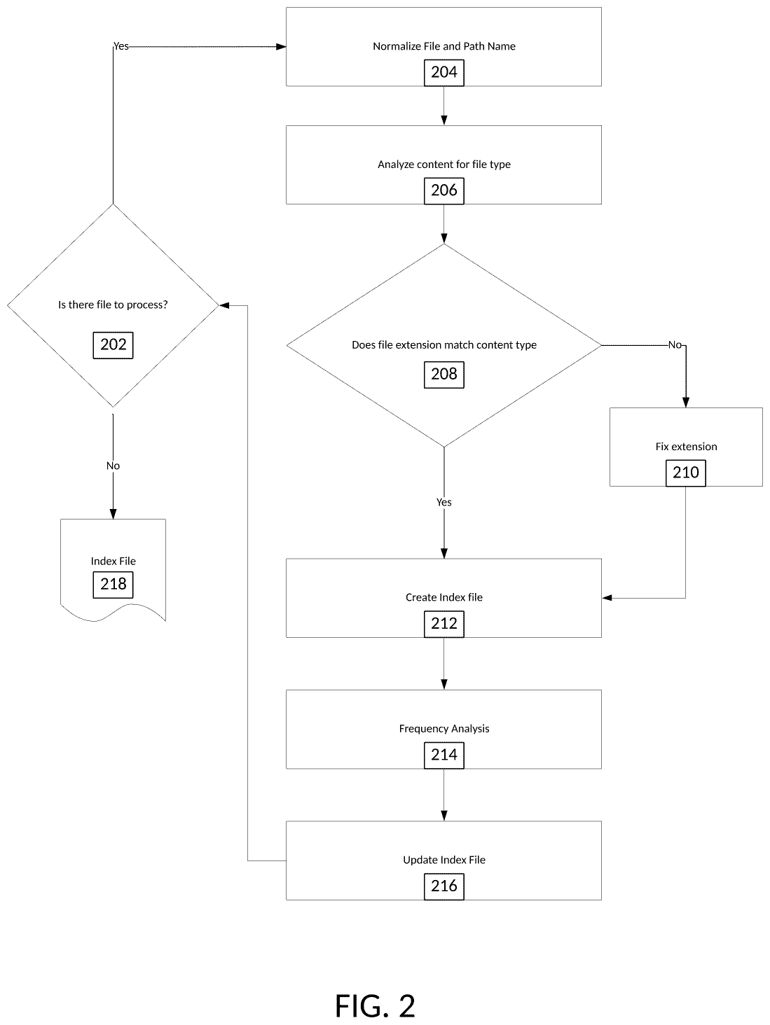

In at least one embodiment, Media Organizer 100 has Index Generator 116. In at least one embodiment, Index Generator 116 is realized as shown in FIG. 2. In at least one embodiment, the Index Generator 116 will create the Index File 212. In at least one embodiment, Index Generator 116 will use one or more methods to enumerate all content that needs to be processed by Media Organizer and represent in a format efficient for algorithmic and machine language processing. In at least one embodiment, the said representation will use any set of characters permitted and will not limit itself to numerical characters.

In at least one embodiment, Index File 212 uses a representation which expresses files and streams as a set of space separated set of characters. In at least one embodiment, the index generation algorithm will differentiate between path and name components of the indexed file or stream. In at least one embodiment, the index generation algorithm will retain information about path in the final representation.

In at least one embodiment, the Index Generator 116 will test the content of file to ensure correctness of elements like file extension. In at least one embodiment, the index generator will use the FourCC code and confirm the correctness of file extension. Where needed, and if so indicated by user via User Interface 138, the extension is made to match the file content.

In at least one embodiment, Index Generator 116 will apply frequency analysis 214 to assess recurrence by name and recurrence of a set by name. In at least one embodiment, Index Generator 116 will use machine language algorithms to find repetition of files by name. In at least one embodiment, Index Generator will apply machine learning techniques like Bag of Words, including but not limited to Term Frequency Inverse Document Frequency method.

Without limit, one sample formulation used is
Term Frequency (TF)=(Number of times term t appears in a document)/(Number of terms in the document)
Inverse Document Frequency (IDF)=log(N/n), where N is the number of documents and n is the number of documents a term t has appeared in. The IDF of a rare word is high, whereas the IDF of a frequent word is likely to be low. Thus, having the effect of highlighting words that are distinct.

We calculate TF-IDF value of a term as =TF*IDF

In at least one embodiment, this is applied iteratively on variations of Index File 212.

In at least one embodiment, the Index Generator 11116 will record results in the Index File.

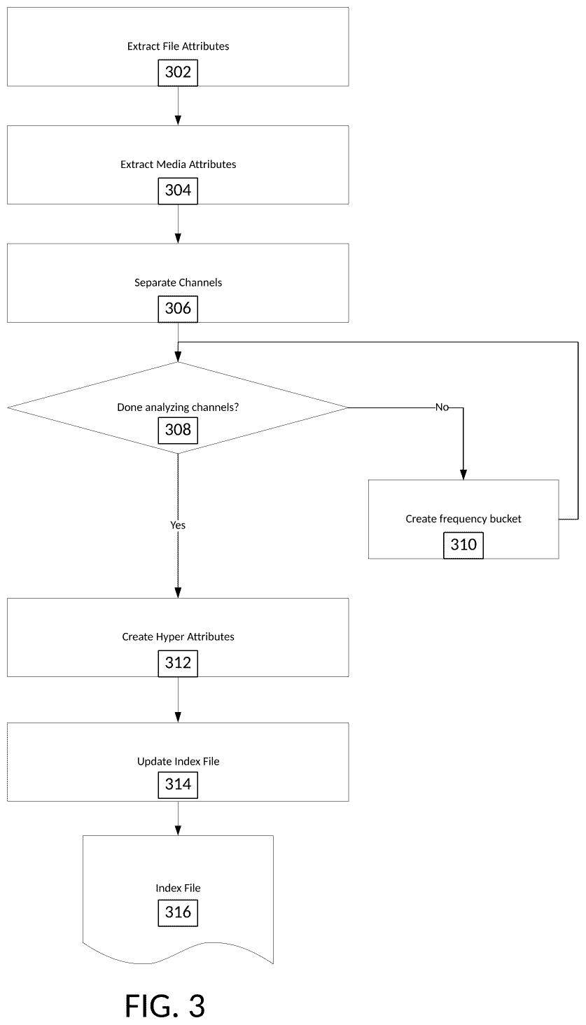

In at least one embodiment, Media Organizer 100 will use an Attribute Parser 118. In at least one embodiment, FIG. 3 represents an Attribute Parser 118.

In at least one embodiment, the Attribute Parser 118 will extract attributes like file name, file type by extension 304, file type by content analysis 304. In at least one embodiment, the Attribute Parser 118 will extract content attributes like resolution and color properties of images and video, encodings, bitrate and sample size of audio 304. In at least one embodiment, Attribute Parser 118 will separate channels of content. In at least one embodiment, Images will be separated into red, green and blue channels 306. Audio will be separated into left and right channels 306.

In at least one embodiment, for all channels, a histogram analysis of the content is done 310. In at least one embodiment, for each of red, green and blue channels a histogram is created by dividing the color space in 10 evenly spaced buckets. For 3 channels this will produce 30 buckets. In at least one embodiment, for audio samples, rate of change of intensity between two consecutive samples is recorded at interval of 10 ms. Channel and bucket count here being representative numbers and can be varied.

In at least one embodiment, Attribute Generator 118 will create Hyper Attributes 140 which are recoded in Index File 314.

In at least one embodiment, Media Organizer 100 will use a Hash Generator 120. In at least one embodiment, the Hash Generator 120 will separate channels 402 and create a hash value 406. In at least one embodiment, the hash generation algorithm will generate 100 hash values over samples covering 100 ms of content over a sliding window of 10 ms for each channel. In at least one embodiment, these parameters of how many hash values to be generated, over what length of time and the step size for sliding window are user defined using user interface 138.

In at least one embodiment, the hash values generated 406 are collected as Hyper Attributes 408 and recorded in Index File 410.

In at least one embodiment, the Media Organizer 100 has a Content Analyzer 122. In at least one embodiment, separates channels and operates similar operations on each of the channels. In at least one embodiment, channels are red, green and blue content for each pixel in an image or left and right audio channels for an audio content.

In at least one embodiment, Content Analyzer 122, will create a reduced dimensional representation of content 506. In at least one embodiment, for images this can be the output of an edge detection algorithm. In at least one embodiment, it can be distance to similar peaks in amplitude of audio content.

In at least one embodiment, Content Analyzer 122 will do spatial compression of content 508. In at least one embodiment, the Content analyzer will create mipmap representation of images. In this formulation, mipmaps or pyramids are pre-calculated, optimized sequences of images, each of which is a progressively lower resolution representation of the same image. The height and width of each image, or level, in the mipmap is a power of two smaller than the previous level. In at least one embodiment, audio samples will be treated as images using techniques like, but not limited to, mel spectrogram. A mel spectrogram is a spectrogram where the frequencies are converted to the mel scale.

In at least one embodiment, Content Analyzer 122 will do temporal compression of content 512. In at least one embodiment, the temporal compression of audio channels is done by N sample skip.

In at least one embodiment, the Content Analyzer 122 will generate Hyper Attributes 514. In at least one embodiment, the Hyper Attributes 514 are stored in Index File 518.

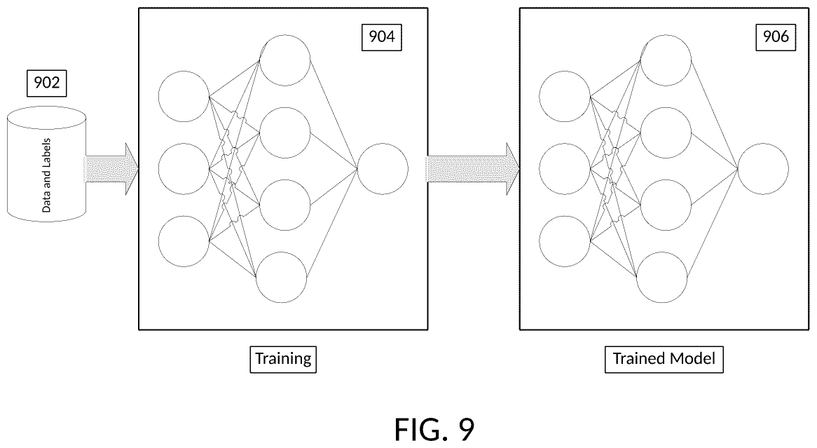

In at least one embodiment, the Media Organizer 100 will use Deep Neural Networks to analyze loss function 124 for each element of the content. In at least one embodiment, loss function 124 is an algorithm that tries to measure difference between desired and achieved results. In at least one embodiment, the loss function 124 reduces to zero when desired result matches achieved results. In at least one embodiment, the Media Organizer 100 has both training and inference capabilities, shown in FIG. 9. In at least one embodiment, Media Organizer 100 is provided with a pre-trained DNN model 904 and input data 902. A training operation produces a trained network 906. There can be a model for each media type. In at least one embodiment, the content is prepared 602 passed through inference 608 and training 604 passes. The loss function will show high errors for first instance of the content. Second and additional occurrences of the same content will show significantly lower loss values. By recording training and inference loss values as Hyper Attributes 610 in the Index File 614 we can analyze for repetition while accounting for overfitting.

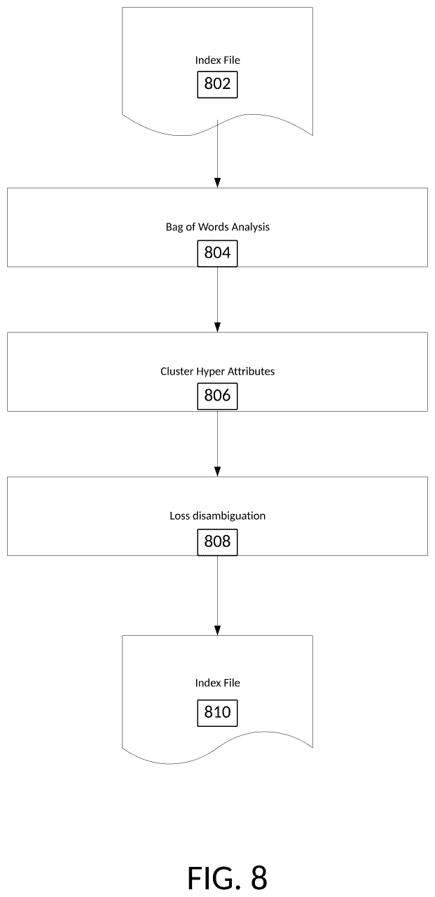

In at least one embodiment, the Media Organizer 100 will need to normalize Hyper Attributes 704. In at least one embodiment, it is possible that ranges in input media is too large and this can be only be determined after going through hyper attribute generation across all content. In at least one embodiment, the final results can be better with a normalization step 704. In at least one embodiment, normalization can be executed with Match Analysis FIG. 8.

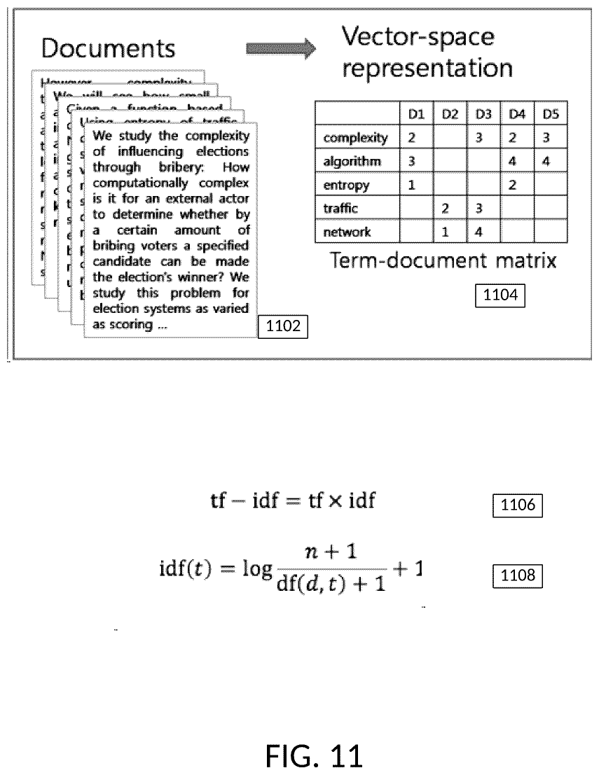

In at least one embodiment, Media Organizer will do Match Analysis FIG. 8 using Index File 802. In at least one embodiment, at this stage all hyper attributes are represented either as strings or numbers or combinations there of. In at least one embodiment, for hyper attributes we apply a machine learning technique called bad of words analysis. In at least one embodiment, Using TF-IDF formulation shown in FIG. 11 for hyper attributes represented as string will show hyper attributes that repeat across our index file 802. Index file 802 is the document 1102 in which the frequency of hyper attribute is assessed in representation 1104 using term frequency 1106 and inverse document frequency 1108.

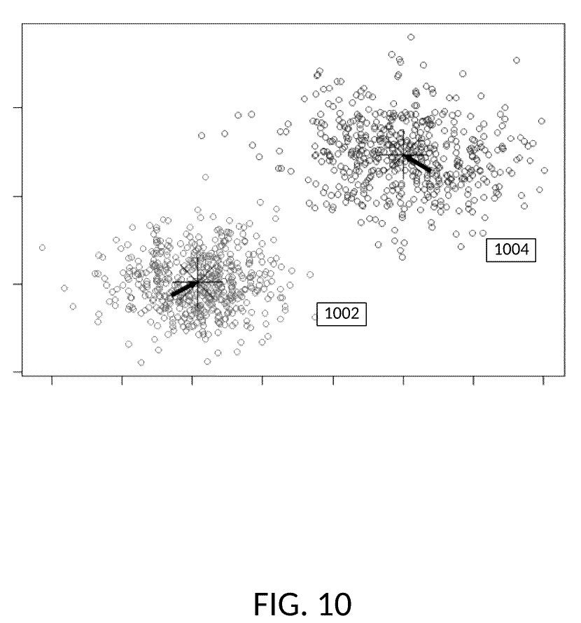

In at least one embodiment, Media Organizer will use clustering approach for hyper attributes that are in numerical format. In at least one embodiment, we will use one or more of K-Means, Mean Shift Clustering, Density Based Spatial Clustering and other machine learning clustering techniques as represented in FIG. 10 where similar results create clusters 1002 and 1003.

In at least one embodiment, Match Analysis 806 will show outliers that will not cluster to a tight pattern. For example, an image rotated through 90 degrees will not cluster with it's original image in this formulation. A DNN based model that has been designed to have it's input vector augmented with such transforms will however be able to detect this with the Loss function disambiguation 808.

In at least one embodiment, Match Analyzer 128 will create a final index file 810 which can be presented to user via user interface 138.

In at least one embodiment, Media Organizer 100 will encounter some hard to determine cases. In at least one embodiment, a user interface 138 will enable human analysis and resolution for such cases.

In at least one embodiment, Media Organizer 100 will use machine learning methods to assess repetition of content based on recurrence of names, part of name or similarity of name of files in same or similar location.

In at least one embodiment, Media Organizer 100 will use derived hyper attributes from media content for the purpose of applying machine learning techniques.

In at least one embodiment, Media Organizer 100 will use a hierarchy of machine learning methods for progressive assessment of duplication. In at least one embodiment, Media Organizer 100 will use a hierarchy of machine learning methods for disambiguation of similar media content. In at least one embodiment, Media Organizer will use a hierarchy of machine learning methods for assessing similarity for media content altered from an original source.

In at least one embodiment, Media Organizer 100 will train an uninitialized DNN with random numbers. In at least one embodiment, Media Organizer 100 will use pre initialized DNN. In at least one embodiment, Media Organizer 100 will use only media content from one user to train DNN. In at least one embodiment, media content from willing users will be pooled to train DNN. In at least one embodiment, training and inference loss will be recorded. In at least one embodiment, either or both training and inference loss will be used to determine repetition of media content.

In at least one embodiment, Media Organizer 100 will train an uninitialized DNN with random numbers. In at least one embodiment, Media Organizer 100 will use pre initialized DNN. In at least one embodiment, Media Organizer 100 will use only media content from one user to train DNN. In at least one embodiment, media content from willing users will be pooled to train DNN. In at least one embodiment, training and inference loss will be recorded. In at least one embodiment, either or both training and inference loss will be used to determine repetition of media content.

In at least one embodiment, training 604 of DNN refers to the operation of providing a sufficiently treated 602 data into a DNN training framework. DNN training framework includes, but not limited to TensorFlow, PyTorch and CNTK. In at least one embodiment, the training operation will evaluate a loss function 608.

In at least one embodiment, inference 604 refers to the operation of testing loss function against an input. In at least one embodiment, Inference is executed in same framework as used for training. In at least one embodiment, Inference is executed as a separate operation. In at least one embodiment, Inference is executed is another programmatic implementation.

In at least one embodiment, the training and inference 604 refers to methods, deep learning or otherwise, to convert speech to text in an audio and/or video media content. In at least one embodiment, the training and inference 604 refers to methods, deep learning or otherwise, to find edges in images. In at least one embodiment, the training and inference 604 refers to methods, deep learning or otherwise, to find motion vectors and/or apply optical flow on video content. Results of such operations contribute to generation of hyper attributes 610.

In at least one embodiment, training and inference 604 is executed in a serial fashion or may be distributed across processes, threads and systems. In at least one embodiment, training and inference 604 may be executed at the same time or at separate times.

In at least one embodiment, Media Organizer 100 will use combination of machine learning and deep learning methods. In at least one embodiment, Media Organizer 100 will use combination of machine and deep learning methods on images, audio, video and other media content.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

Described as a software implementation, one or more or all of these steps can be equivalently, with more or less impact, be realized as a combination of software and processors and circuits.

Unless specifically stated otherwise, it may be appreciated that throughout specification terms such as “processing,” “computing,” “calculating,” “determining,” “generate,” “create,” “derive,” “produce,” “operate,” “evaluate” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from any manner of source. As non-limiting examples, “processor” may be a CPU or a GPU. A “computing platform” may comprise one or more processors. As used herein, “software” processes may include, for example, software and/or hardware entities that perform work overtime, such as tasks, threads, and processes. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

Herein, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanisms.

Although discussion above sets forth example implementations of described techniques, other architectures may be used to implement described functionality, and are intended to be within scope of this disclosure. Furthermore, even though specific distributions of responsibilities are defined above for purposes of discussion, various functions and responsibilities might be distributed and divided in different ways, depending on need and choices made.

Although discussion above refers to some specific concepts of machine learning and deep learning as examples, it is intended to describe some of the options from the wider fields of machine learning and deep learning. Further it is submitted that machine learning is a field that includes deep learning as a specialization. References to one or both are meant to imply applications of either or both.

Furthermore, although subject matter has been described in manner specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, method and/or application programming interface (API) comprising use of one or more machine leaning method and/or one or deep learning methods and/or neural networks to identify similarity between two or more files of media content, at least in part, based on apparent and/or derived properties from one or more of referenced media.

2. The processor, method and/or application programming interface (API) of claim 1, wherein one or more operations are to use one or more machine learning and/or one or more deep learning methods and/or neural networks to identify one or more repetitions of media content by some or all of:
obtaining media content comprising images, audio and video;
determining, an identifier based at least in part on the method of storage and/or transmission of the media content;
determining unique nature of the media type and properties for each;
separating media content into channels of color, audio and frames;
creating representations that allow application of machine learning and deep learning methods;
creating and updating all such representations in a document format.

3. The processor, method and/or application programming interface (API) of claim 1, wherein determining repetition comprises some or all of:
identifying nature of media content and it's embedded properties;
determining unique identifiers within different representations of the media content;
identifying operations that when applied to one or more such representations of media content, will generate sequence of characters;
creating, updating and maintaining a document that collects such sequence of characters; and
apply computer vision methods; and
apply signal processing methods; and
apply machine learning and deep learning methods to such document and media content.

4. The processor, method and/or application programming interface (API) of claim 1, wherein:
determining that the media content is repeated comprises determining patterns in contents of document generated by iterative application of algorithms.

5. The processor, method and/or application programming interface (API) of claim 1, wherein the measure of similarity is tested against a threshold score.

6. The processor, method and/or application programming interface (API) of claim 1, wherein determination of repetition of media content is done by performing speech to text conversion of audio content included as part of media content.

7. The processor, method and/or application programming interface (API) of claim 1, determining repetitions at least in part on the content of the media:
determining text data from the audio component;
parsing the text data using a natural language understanding routine to determine repetitions of select words and phrases.

8. The processor, method and/or application programming interface (API) of claim 1, wherein the one or more steps are to further:
apply computer vision methods; and
apply signal processing methods; and
apply machine learning and deep learning methods to such document and media content.
determine whether the one or more objects, faces and other entities detected in the video component are repeated by applying object detection, face detection and similar detection and identification methods

9. The processor, method and/or application programming interface (API) of claim 1, wherein the hyper attribute encodes obvious and derived properties of the media content and such encodings are used to determine repetitive nature of media.

10. The processor, method and/or application programming interface (API) of claim 1, wherein the determination that the second media content is a repeat is made by comparing a threshold against a loss function score, final and/or intermediate layer outputs determined based at least in part on the training and/or inference operation.
